(19) United States
(12) Patent Application Publication
(10) Pub. No.: US 2018/0022348 A1
(43) Pub. Date: Jan. 25, 2018

(54) METHODS AND SYSTEMS FOR DETERMINING LANE HEALTH FROM AN AUTONOMOUS VEHICLE

(71) Applicant: GM GLOBAL TECHNOLOGY OPERATIONS LLC, Detroit, MI (US)

(72) Inventors: Kevin Chu, San Mateo, CA (US); Shiva Ghose, Berkeley, CA (US)

(73) Assignee: GM GLOBAL TECHNOLOGY OPERATIONS LLC, Detroit, MI (US)

(21) Appl. No.: 15/706,197

(22) Filed: Sep. 15, 2017

(51) Int. Cl. B60W 30/12; G08G 1/16; G01C 21/28; G05D 1/00; G05D 1/02

(52) U.S. Cl. CPC B60W 30/12; G05D 1/0088; G05D 1/0274; G01C 21/28; G08G 1/161; G08G 1/167; G05D 2201/0213; B60W 2550/14; B60W 2550/402

(57) ABSTRACT

Systems and method are provided for controlling an autonomous vehicle. In one embodiment, a method includes: receiving, by a processor, sensor data associated with an environment of a first autonomous vehicle; determining, by a processor, lane health information based on the sensor data; and selectively controlling, by a processor, a second autonomous vehicle based on the lane health information.

### TECHNICAL FIELD

The present disclosure generally relates to autonomous vehicles, and more particularly relates to systems and methods for determining lane health and managing lane health information from an autonomous vehicle.

### INTRODUCTION

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

The information sensed from environment can be used to determine obstacles and other vehicles nearby the vehicle, for example in lanes adjacent to the vehicle, in the same lane of the vehicle, in lanes the vehicle passes by, etc. The sensed information is obtained in realtime, as the vehicle is driving. Accordingly, it is desirable to provide systems and methods that take advantage of this realtime information and other information to determine a health of lanes nearby the vehicle. It is further desirable to manage the lane health information from multiple vehicles. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a vehicle. In one embodiment, a method includes: receiving, by a processor, sensor data associated with an environment of a first autonomous vehicle; determining, by a processor, lane health information based on the sensor data; and selectively controlling, by a processor, a second autonomous vehicle based on the lane health information. The sensor data is obtained by at least one of a lidar, a radar, and a camera that senses an environment of the autonomous vehicle.

The method further includes processing the sensor data to determine map data associated with the environment, and wherein the determining the lane health is based on the map data associated with the environment. The map data is based on Simultaneous Localization and Mapping techniques.

The method further includes processing the sensor data to determine object data associated with the environment, and wherein the determining the lane health is based on the object data associated with the environment. The object data includes at least one of object speed data, object acceleration data, and object classification data.

The method further includes processing the sensor data to determine vehicle location data in relation to the environment and wherein the determining the lane health is based on the vehicle location data in relation to the environment.

The method further includes processing the lane health information from the first vehicle with lane health information from at least one other vehicle to determine an overall lane health, and wherein the selectively controlling is based on the overall lane health.

The lane health information indicates the health of a lane of a road.

The method further includes at least one of determining if multiple riders can ride together, determining when to dispatch an autonomous vehicle, determining which autonomous vehicle to dispatch from a plurality of autonomous vehicles, and determining a route including which lane of the route for the autonomous vehicle, and wherein the selectively controlling is based on the determining.

In another embodiment a system form controlling an autonomous vehicle is provided. The system includes a first non-transitory module that, by a processor, receives sensor data associated with an environment of a first autonomous vehicle. The system further includes a second non-transitory module that, by a processor, determines lane health information based on the sensor data. The system further includes a third non-transitory module that, by a processor, selectively controls a second autonomous vehicle based on the lane health information. The sensor data is obtained by at least one of a lidar, a radar, and a camera that senses an environment of the autonomous vehicle.

The system further includes a fourth non-transitory module that, by a processor, processes the sensor data to determine map data associated with the environment, and wherein the second non-transitory module determines the lane health based on the map data associated with the environment. The map data is based on Simultaneous Localization and Mapping techniques.

The system further includes a fourth non-transitory module that, by a processor, processes the sensor data to determine object data associated with the environment, and wherein the second non-transitory module determines the lane health based on the object data associated with the environment. The object data includes at least one of object speed data, object acceleration data, and object classification data.

The system further includes a fourth non-transitory module that, by a processor, processes the sensor data to determine vehicle location data in relation to the environment, and wherein the third non-transitory module determines the lane health based on the vehicle location data in relation to the environment.

The system further includes a fourth module that, by a processor, processes the lane health information from the first vehicle with lane health information from at least one other vehicle to determine an overall lane health, and wherein the third non-transitory module selectively controls based on the overall lane health.

The system further includes a fourth module that, by a processor, determines at least one of if multiple riders can ride together, determining when to dispatch an autonomous vehicle, which autonomous vehicle to dispatch from a plurality of autonomous vehicles, and a route including which lane of the route for the autonomous vehicle, and wherein the third non-transitory module selectively controls based on the determining.

In another embodiment an autonomous vehicle is provided. The autonomous vehicle includes at least one of a camera, a lidar, and a radar that senses an environment of the autonomous vehicle and that generates sensor data. The autonomous vehicle further includes a controller that, by a processor, receives the sensor data, determines lane health information based on the sensor data, and communicates the lane health information to a remote location for selectively controlling a second autonomous vehicle based on the lane health information.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a lane health monitoring system, in accordance with various embodiments;

FIG. 2 is a functional block diagram illustrating a transportation system having one or more autonomous vehicles of FIG. 1, in accordance with various embodiments;

FIGS. 3, 4, and 5 are dataflow diagrams illustrating an autonomous driving system that includes the lane health monitoring system of the autonomous vehicle, in accordance with various embodiments; and

FIGS. 6, 7, and 8 are flowcharts illustrating lane health monitoring methods of the autonomous driving system, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

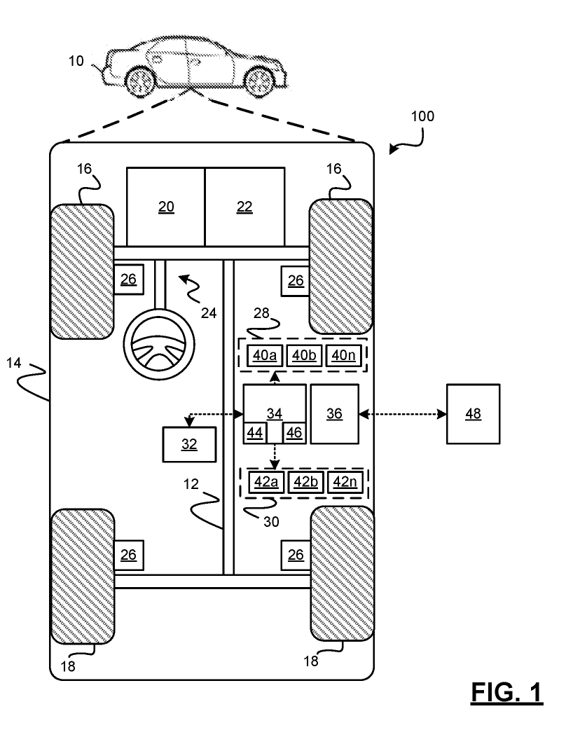

With reference to FIG. 1, a lane health management system shown generally at 100 is associated with a vehicle 10 in accordance with various embodiments. In general, the lane health monitoring system 100 processes realtime information of the vehicle to determine a health of one or more lanes nearby the vehicle. As used herein, the term “health” refers to the ability of the lane to function as a lane, by permitting traffic to flow freely without any type of disruption to a vehicle in the lane. The lane health monitoring system 100 communicates lane health information to remote vehicles or systems. The lane health monitoring system 100 further compiles the health of lanes determined from multiple vehicles and makes the compiled information available for use by the remote system and/or other vehicles, such as for use in coordinating a route for a vehicle including which lane of the roads to take during the route.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the lane health monitoring system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

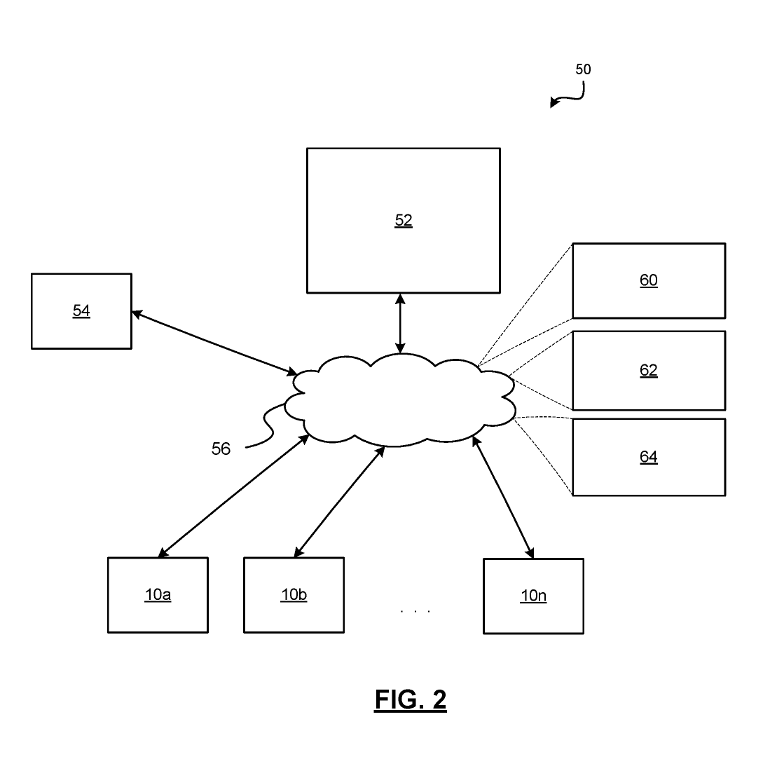

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, implement functions of an autonomous driving system 70 such as, but not limited to, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the lane health monitoring system 100. The lane health monitoring system 100, when executed by the processor 44, processes data from the signals received from the sensor system 28 along with information of the autonomous vehicle 10 to determine a health of one or more lanes nearby the autonomous vehicle 10, and communicate the information about the health of the lanes to a system remote from autonomous vehicle 10 or to other vehicles for further processing. In various embodiments, the instructions of the controller 34 make use of the information about the health of the lanes to determine navigation of the autonomous vehicle 10.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, at least one of the autonomous vehicles 10a, a number of the autonomous vehicles 10a-10n, or all of the autonomous vehicles 10a-10n includes includes the lane health monitoring system 100 as described herein. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In various embodiments, the remote transportation system 52 receives lane health information from the autonomous vehicles 10a-10b and compiles the lane health information. The remote transportation system 52 computes an overall lane health based on the compiled lane health information. In various embodiments the remote transportation system 52 makes use of the overall lane health for coordinating rides, dispatching vehicles, and determining routes.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time based on the compiled lane health information. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

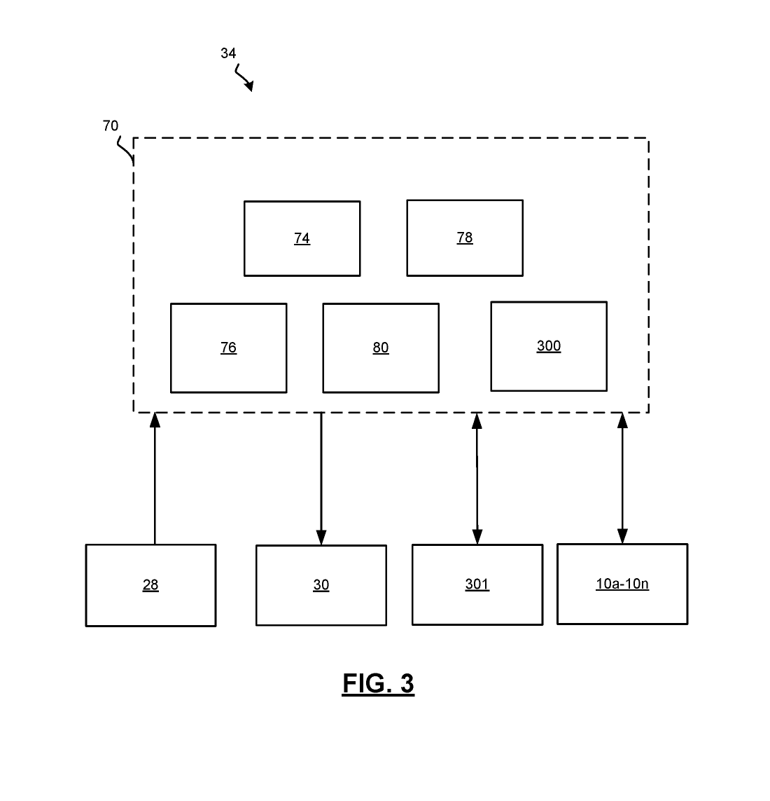

Referring now to FIG. 3, and with continued reference to FIG. 1, a dataflow diagram illustrates various embodiments of an autonomous driving system (ADS) 70 which may be embedded within the controller 34 and which may include parts of the lane health monitoring system 100 in accordance with various embodiments. That is, suitable software and/or hardware components of controller 34 (e.g., processor 44 and computer-readable storage device 46) are utilized to provide an autonomous driving system 70 that is used in conjunction with vehicle 10.

Inputs to the autonomous driving system 70 may be received from the sensor system 28, received from other control modules (not shown) associated with the autonomous vehicle 10, received from the communication system 36, and/or determined/modeled by other sub-modules (not shown) within the controller 34. In various embodiments, the instructions of the autonomous driving system 70 may be organized by function or system. For example, as shown in FIG. 3, the autonomous driving system 70 can include a sensor fusion system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the sensor fusion system 74 synthesizes and processes sensor data and predicts the presence, location, classification, and/or path of objects and features of the environment of the vehicle 10. In various embodiments, the sensor fusion system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as obstruction mitigation, route traversal, mapping, sensor integration, ground-truth determination, and feature detection, and object classification as discussed herein.

As mentioned briefly above, the lane health monitoring system 100 of FIG. 1 is included within the autonomous driving system 70, for example, as a lane health monitoring system 300. The lane health monitoring system 300 receives localization and mapping output that includes the position and orientation of the vehicle 10 with respect to detected objects and road features, and observation output that includes observations by the vehicle or other vehicles and system of objects or other elements of the environment. The lane health monitoring system 300 processes the localization and mapping output to determine lanes of the road from the road features of the map. The lane health monitoring system 300 further processes the observation output to determine lane health information associated with each lane. The lane health information can include, for example, but is not limited to, a density of vehicles traveling in the lane, an average speed of the vehicles traveling in the lane, and an average velocity of the vehicles traveling in the lane. In various embodiments, the lane health information can further include road quality issues in the lane such as, but not limited to, debris on the road, potholes, gravel or dirt, or puddles of water. In various embodiments, the lane health information can further include indicators of lane activity such as police activity, or blockages from demonstrations or construction. In various embodiments, the lane health information can further includes vehicle information associated with the lane such as, but not limited to, dead spots for wifi or other functional limitations.

The lane health monitoring system 300 communicates the lane health information to a remote access center 301 and/or other vehicles 10a-10n for further processing. In various embodiments, the communication can be human supervised, for example, requiring a human of the remote access center 301 to confirm the received information and then approve it into the system of the remote access center 301 or unsupervised, for example, communicating it directly to the other vehicles 10a-10n for immediate use. In various embodiments, a vehicle 10a of the vehicle fleet 10a-10n can be dedicated to monitoring lane heath, referred to as a “scout car” or alternatively, every vehicle 10a-10n can perform lane health monitoring and/or navigation based on the lane health at some level.

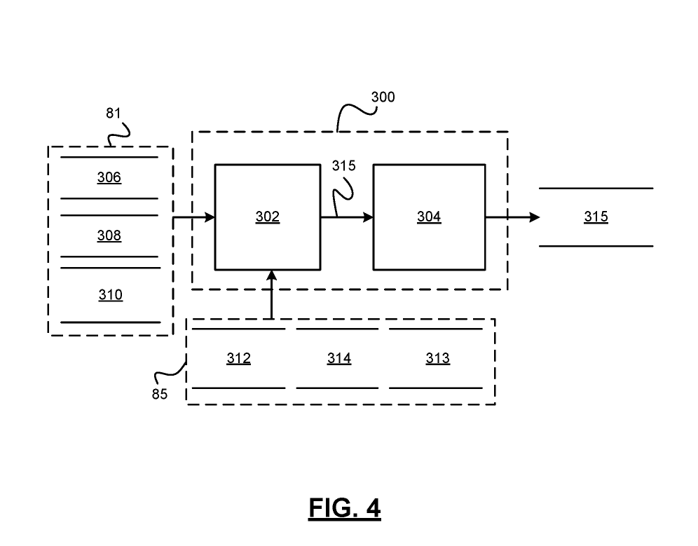

As shown in more detail with regard to FIG. 4 and with continued reference to FIG. 3, the lane health monitoring system 300 includes, in various embodiments, a lane data collection module 302 and a data communication module 304. The lane data collection module 302 receives localization and mapping output 81 and observation output 85. In various embodiments, the localization and mapping output 81 includes map data 306, object data 308, and vehicle location data 310. The map data 306 includes a relative map of the roadways in proximity to the vehicle. The maps can be pre-constructed and downloaded to the vehicle and/or be constructed by the vehicle in realtime based on sensor data. The object data 308 includes information about known objects along the roadway and/or near the roadway in proximity to the vehicle, such as, but not limited to classification data, acceleration data, and/or speed data and can be extracted from sensor data. The vehicle location data 310 includes a position of the vehicle within a lane along the roadway and can be determined from map data and sensor data.

In various embodiments, the observation output 85 indicates observations of the sensors of the vehicle. In various embodiments, the observation output 85 includes vehicle data 312 (e.g., vehicle speed and/or acceleration, vehicle wifi or other capabilities, etc.), road data 314 (e.g., detected potholes, puddles of water, surface type, etc.) and activity data 313 (e.g., detected police activity, construction activity, etc.). The vehicle data 312 can be determined from, for example, vehicle sensors (e.g., wheel speed sensors, engine speed sensors, etc.). The road data 314 can be determined from image sensors, lidar, radar, etc. The activity data 313 can be determined from microphones, image sensors, lidar, radar, etc.

The lane data collection module 302 processes and assembles the received data 81, 85 into lane health information 315. In various embodiments, the type or level of processing and/or assembling of the received data 81, 85 may be based on whether the communication will be sent to the remote access center 301 (e.g., to accumulate a rich dataset for further processing) or the other vehicles 10a-10n (e.g., for fast, realtime processing of the received data). In various embodiments, the type or level of processing and/or assembly of received data 81, 85 can be based on the bandwidth that is available for communication. For example, the lane data collection module 302 may assemble all of the data without much processing for larger bandwidths, assemble a certain some of the data with some processing for medium bandwidths, and/or may assemble only a lane condition indicated by the data with some processing for smaller bandwidths.

In various embodiments, in order to assemble a certain some of the data, the lane data collection module 302 may parse out certain data having values within a range or above/below a threshold which may be indicative of a certain lane condition. As can be appreciated, other methods of selecting a certain some of the data can be implemented in various embodiments. In various embodiments, in order to assemble only a lane condition, the lane data collection module 302 processes the received data to classify the data as a certain lane condition using, for example, a machine learning model (e.g., a decision tree, a neural network or the like) that has been trained via supervised or unsupervised learning. As can be appreciated, other methods of generating a lane condition can be implemented in various embodiments.

In various embodiments, the lane data collection module 302 assembles with the data a timestamp, a location and/or other information to identify the assembled information.

The data communication module 304 receives the lane health information 315 assembled by the lane data collection module 302 and communicates the lane health information 315 to the remote access center 301 and/or the other vehicles 10a-10n. The data communication module 304 communicates the lane health information 315 at scheduled intervals, based on predetermined events, based on a location of the vehicle, or other criteria.

With reference back to FIG. 3, the remote access center 301 receives the lane health information 315. The remote access center 301 compiles the lane health information 315 from the autonomous vehicle 10 with lane health information 315 from other autonomous vehicles 10a-10n. Based on the compiled lane health information 315, the remote access center 301 computes an overall lane health for each lane of a map having corresponding lane health information. In various embodiments, when the remote access center 301 is the remote transportation system 52, the remote transportation system 52 makes use of the overall lane health for coordinating rides, dispatching vehicles, and determining routes; and communicates the overall lane health, and the dispatch info, ride info, and/or route info back to one or more of the autonomous vehicles 10a-10n.

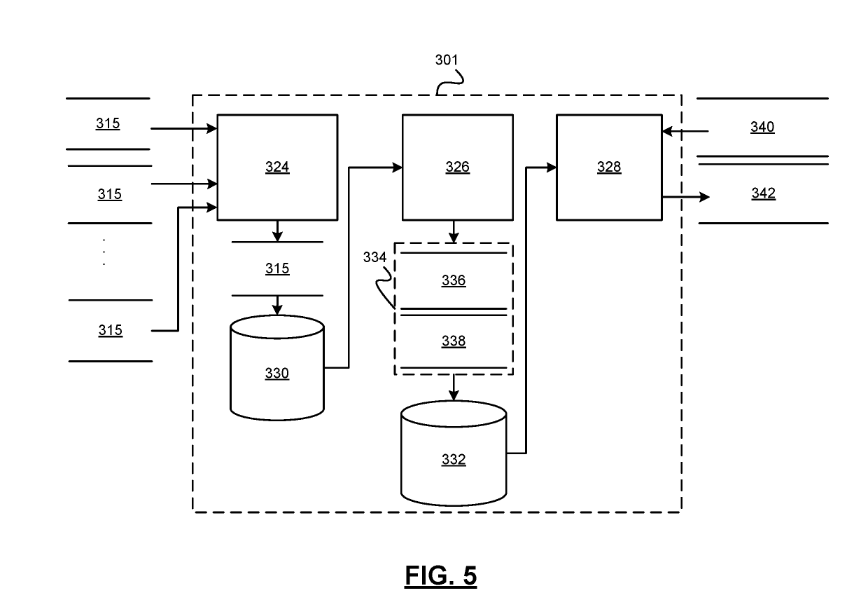

For example, as shown in more detail with regard to FIG. 5 and with continued reference to FIG. 3, the remote access center 301 includes a data communication module 324, an overall lane health determination module 326, a logistics determination module 328, a lane health information datastore 330, and an overall lane health datastore 332. The data communication module 324 receives the lane health information 315 from the autonomous vehicle 10 and the other autonomous vehicles 10a-10n. The data communication module 324 compiles the lane health information 315 in the lane health information datastore 330. For example, data communication module 324 compiles the information based on the time and/or location provided with the lane health information 315. As can be appreciated, other methods of compiling the data can be implemented in various embodiments.

The overall lane health determination module 326 retrieves the lane health information 315 from the lane health information datastore 330 and computes an overall lane health 334. For example, the overall lane heath determination module 326 retrieves overall lane health information 334 related to a particular lane at a particular location based on a request, at scheduled intervals, and/or based on an occurrence of an event or condition (e.g., when a certain amount of information has been accumulated for the particular location, etc.). The overall lane health determination module 326 computes or classifies an overall lane health as 3-blocked, 2-slow/uncomfortable, 1-fine or other level based a machine learning model (e.g., a decision tree, a neural network or the like) that has been trained via supervised or unsupervised learning. The overall lane health determination module 326 stores the computed overall lane health information 334 including, but not limited to, a lane and/or location identifier 336, and the overall lane health 338 in the overall lane health datastore 332.

The logistics determination module 328 receives request data 340. Based on the request data 340, the logistics determination module 328 retrieves the computed lane health information 334 from the overall lane health datastore 332 and uses the overall lane health information 334 in determining if multiple riders can ride together, determining when to dispatch an autonomous vehicle, determining what autonomous vehicle to dispatch, and determining a route including which lane of the route for the autonomous vehicle. The logistics determination module 328 provides a recommendation 342 based on the determination.

As can be appreciated, all or parts of the modules 324, 326, and 328 discussed with regard to the remote access center 301 in FIG. 5 can be implemented in the other vehicles in various embodiments. For example, when implemented within another vehicle, the accumulated data in the lane health information datastore 330 may be accumulated data from nearby vehicles and/or vehicles along a planned path of a vehicle; and the accumulated data is used to confirm or predict an overall lane health 334 for the upcoming route and adjust the route and/or lane of the route.

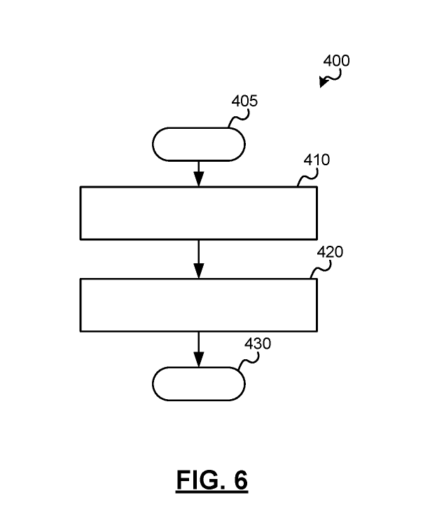

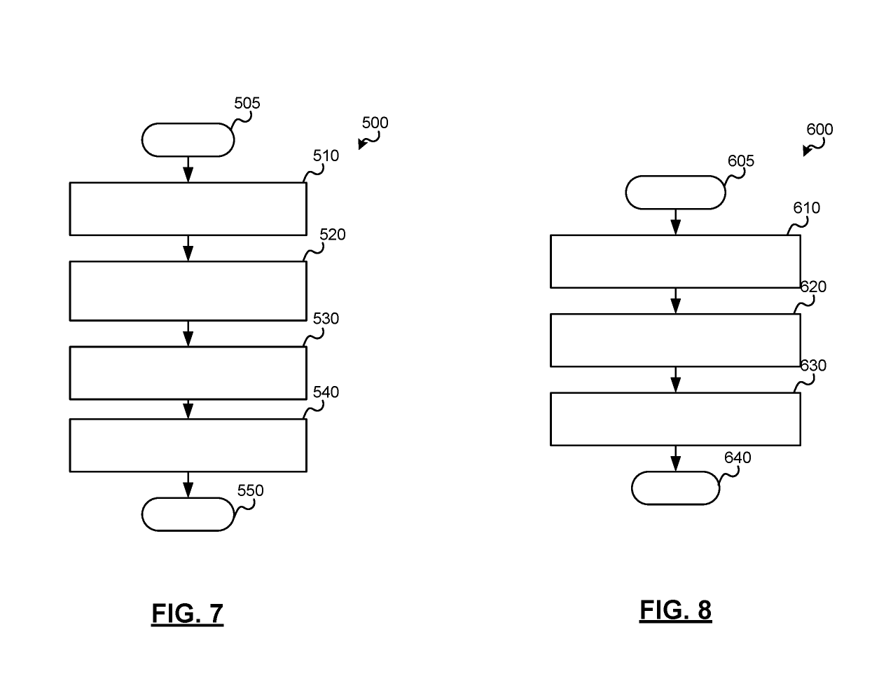

Referring now to FIGS. 6-8, and with continued reference to FIGS. 1-5, a flowchart illustrates control methods 400, 500, and 600 that can be performed by the lane health monitoring system 100 of FIG. 1 in accordance with the present disclosure. As can be appreciated in light of the disclosure, the order of operation within the methods is not limited to the sequential execution as illustrated in FIGS. 6-8, but may be performed in one or more varying orders as applicable and in accordance with the present disclosure. In various embodiments, the methods 400, 500, and 600 can be scheduled to run based on one or more predetermined events, and/or can run continuously during operation of the autonomous vehicle 10.

In various embodiments, the method 400 can be performed by the lane health monitoring system 300 of the autonomous vehicle 10. The method may begin at 405. The lane health information 315 is collected from the localization and mapping output 81 and the observation output 85 as discussed above. The lane health information 315 is then selectively communicated to the remote access center 301 and/or other vehicles 10a-10n at 420. Thereafter, the method may end at 430.

In various embodiments, the method 500 can be performed by the remote access center 301. The method may begin at 505. The lane health information 315 is received at 510 and compiled at 520. The overall lane health 334 is computed as discussed above at 530 and stored in the overall lane health datastore 332 at 540. Thereafter, the method may end at 550.

In various embodiments, the method 600 can be performed by the remote access center 301 and/or other vehicles 10a-10n. The method may begin at 605. The request data 340 is received indicating a location and a request for a recommendation given lane health at the location at 610 (e.g., based on a request from a vehicle, an occurrence of interval of time, or other event). The overall lane health 334 is retrieved from the overall lane health datastore 332 based on the location indicated in the request at 620. The recommendation is determined based on the overall lane health 334 at 630. Thereafter, the method may end at 640. As can be appreciated, alternatively the request can be a condition or scheduled time, and/or the

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling an autonomous vehicle, comprising:
receiving, by a processor, sensor data associated with an environment of a first autonomous vehicle;
determining, by a processor, lane health information based on the sensor data; and
selectively controlling, by a processor, a second autonomous vehicle based on the lane health information.

2. The method of claim 1, wherein the sensor data is obtained by at least one of a lidar, a radar, and a camera that senses an environment of the autonomous vehicle.

3. The method of claim 1, further comprising processing the sensor data to determine map data associated with the environment, and wherein the determining the lane health is based on the map data associated with the environment.

4. The method of claim 1, further comprising processing the sensor data to determine observation data associated with the vehicle, wherein the observation data includes at least one of vehicle data, road data, and activity data.

5. The method of claim 1, further comprising processing the sensor data to determine object data associated with the environment, and wherein the determining the lane health is based on the object data associated with the environment.

6. The method of claim 5, wherein the object data includes at least one of object speed data, object acceleration data, and object classification data.

7. The method of claim 1, further comprising processing the sensor data to determine vehicle location data in relation to the environment, and wherein the determining the lane health is based on the vehicle location data in relation to the environment.

8. The method of claim 1, further comprising processing the lane health information from the first vehicle with lane health information from at least one other vehicle to determine an overall lane health, and wherein the selectively controlling is based on the overall lane health.

9. The method of claim 1, wherein the lane health information indicates the health of a lane of a road.

10. The method of claim 1, further comprising at least one of determining if multiple riders can ride together, determining when to dispatch an autonomous vehicle, determining which autonomous vehicle to dispatch from a plurality of autonomous vehicles, and determining a route including which lane of the route for the autonomous vehicle, and wherein the selectively controlling is based on the determining.

11. A system for controlling an autonomous vehicle, comprising:
a first non-transitory module that, by a processor, receives sensor data associated with an environment of a first autonomous vehicle;
a second non-transitory module that, by a processor, determines lane health information based on the sensor data; and
a third non-transitory module that, by a processor, selectively controls a second autonomous vehicle based on the lane health information.

12. The system of claim 11, wherein the sensor data is obtained by at least one of a lidar, a radar, and a camera that senses an environment of the autonomous vehicle.

13. The system of claim 11, further comprising a fourth non-transitory module that, by a processor, processes the sensor data to determine map data associated with the environment, and wherein the second non-transitory module determines the lane health based on the map data associated with the environment.

14. The system of claim 11, further comprising a fourth non-transitory module that, by a processor, processes the sensor data to determine observation data associated with the vehicle, wherein the observation data includes at least one of vehicle data, road data, and activity data.

15. The system of claim 11, further comprising a fourth non-transitory module that, by a processor, processes the sensor data to determine object data associated with the environment, and wherein the second non-transitory module determines the lane health based on the object data associated with the environment.

16. The system of claim 15, wherein the object data includes at least one of object speed data, object acceleration data, and object classification data.

17. The system of claim 11, further comprising a fourth non-transitory module that, by a processor, processes the sensor data to determine vehicle location data in relation to the environment, and wherein the third non-transitory module determines the lane health based on the vehicle location data in relation to the environment.

18. The system of claim 11, further comprising a fourth module that, by a processor, processes the lane health information from the first vehicle with lane health information from at least one other vehicle to determine an overall lane health, and wherein the third non-transitory module selectively controls based on the overall lane health.

19. The system of claim 11, further comprising a fourth module that, by a processor, determines at least one of if multiple riders can ride together, determining when to dispatch an autonomous vehicle, which autonomous vehicle to dispatch from a plurality of autonomous vehicles, and a route including which lane of the route for the autonomous vehicle, and wherein the third non-transitory module selectively controls based on the determining.

20. An autonomous vehicle, comprising:
at least one of a camera, a lidar, and a radar that senses an environment of the autonomous vehicle and that generates sensor data; and
a controller that, by a processor, receives the sensor data, determines lane health information based on the sensor data, and communicates the lane health information to a remote location for selectively controlling a second autonomous vehicle based on the lane health information.
